(19) United States
(12) Patent Application Publication
(10) Pub. No.: US 2011/0217134 A1
(43) Pub. Date: Sep. 8, 2011

(54) ROTATING SHAFT SAW

(76) Inventor: Mark Rizzo, Hutchinson, KS (US)

(21) Appl. No.: 13/038,736

(22) Filed: Mar. 2, 2011

Related U.S. Application Data
(60) Provisional application No. 61/309,514, filed on Mar. 2, 2010.

(51) Int. Cl. B23B 51/04

(52) U.S. Cl. 408/209

(57) ABSTRACT

A cutting apparatus may comprise a cutting head having a cutting edge that may be operable to cut through a surface, a pilot drill bit that may be operably coupled to the cutting head, a housing, and an inner shaft that may have at least a portion housed within the housing. The inner shaft may be operably coupled to the cutting head. The inner shaft may also be rotatable to cause the cutting head to rotate according to a rotation of the inner shaft to cut a circular shape. The apparatus may be used to cut through one or more surfaces, such as a soffit and a roof, from underneath the soffit and the roof.

### CROSS-REFERENCE TO RELATED APPLICATIONS

This application claims the benefit of priority to U.S. provisional patent application No. 61/309,514 filed Mar. 2, 2010, and is incorporated herein by reference.

### BACKGROUND OF THE INVENTION

The present invention generally relates to a cutting apparatus, and more specifically relates to a rotating shaft saw.

Currently, electricians may need to cut through surfaces of a building, such as the soffit and roof of a home, in order to install an electrical mast for that building. However, current methods of cutting through the soffit and the roof may pose a danger to the electrician. For example, the electrician man need to climb onto the roof to cut the necessary hole on the roof, thus increasing the danger to the electrician.

As can be seen, there is a need for a cutting tool that allows a user to more safely and easily cut through surfaces of a building.

### SUMMARY OF THE INVENTION

In one aspect of the present invention, a cutting apparatus comprises a cutting head having a cutting edge that is operable to cut through a surface; a pilot drill bit operably coupled to the cutting head; a housing; and an inner shaft having at least a portion housed within the housing, the inner shaft being operably coupled to the cutting head, and the inner shaft being rotatable to cause the cutting head to rotate according to a rotation of the inner shaft to cut a circular shape.

These and other features, aspects and advantages of the present invention will become better understood with reference to the following drawings, description and claims.

### BRIEF DESCRIPTION OF THE DRAWINGS

FIG. 1 shows a perspective view of a rotating shaft saw in accordance with an embodiment of the present invention;

FIG. 2 shows a section view of the rotating shaft saw of FIG. 1 taken along line 2-2 of FIG. 1; and

FIG. 3 shows an exploded perspective view of the rotating shaft saw of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a rotating shaft saw that may be used by a user to more easily and safely cut through one or more surfaces of a building. For example, an electrician may use the rotating shaft saw to cut through a soffit of a roof of a building as well as the roof of the building while situated underneath the soffit and the roof, instead of needing to stand on the roof of the building to cut through the roof from above the roof.

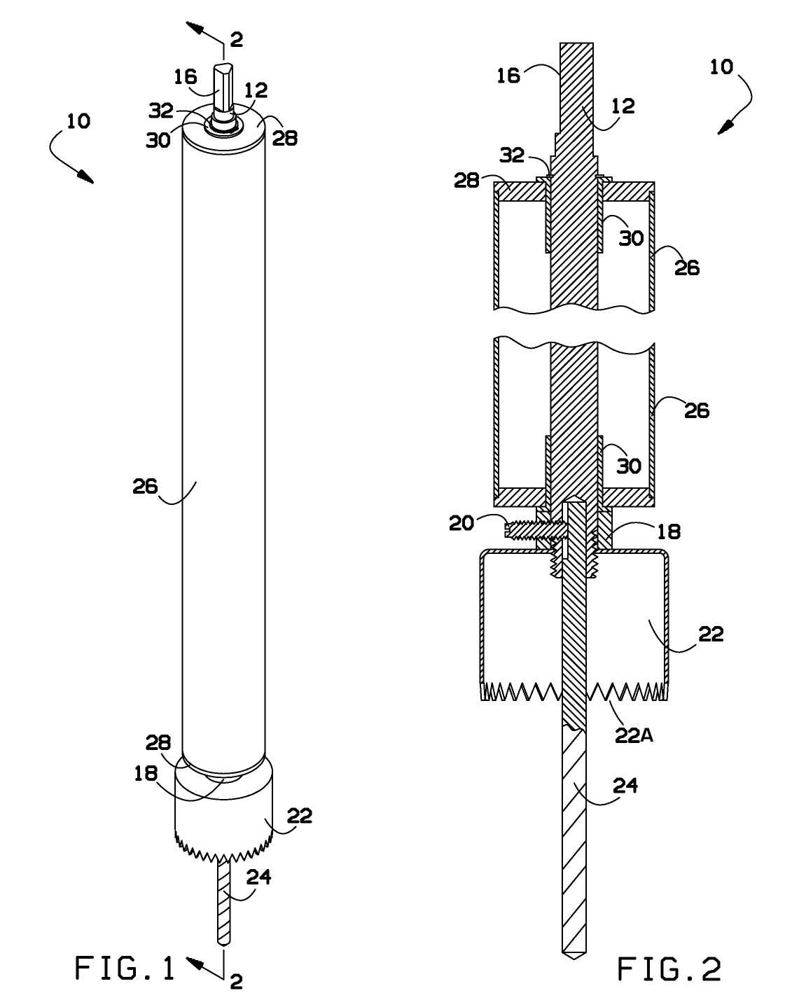

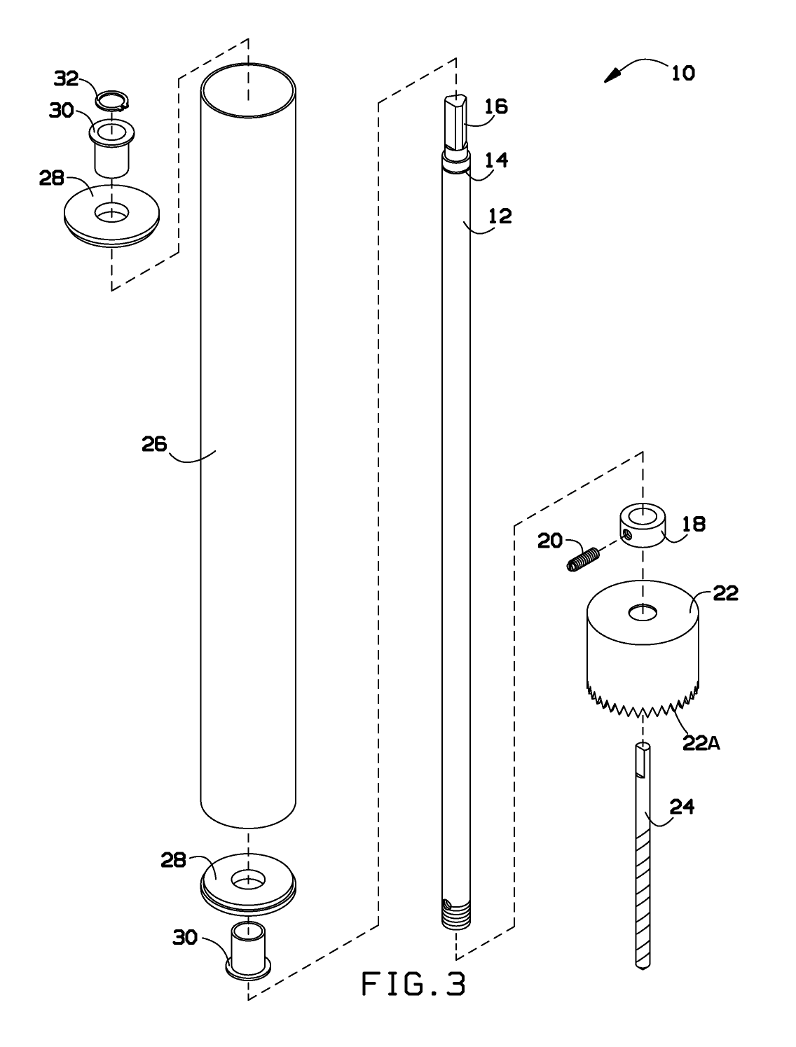

Referring now to FIGS. 1-3, a rotating shaft saw 10 may comprise a cutting head 22 having a cutting edge 22A that is operable to cut through a surface, such as the soffit and roof of a building. The cutting head 22 may be cylindrical in shape and may be operably coupled to an inner shaft 12. The cutting edge 22A may be a serrated edge that lines the circumference of the cutting edge 22A cylinder. A pilot drill bit 24 may be operably coupled with the cutting head 22 and the inner shaft 12, and may protrude from the cutting head 22. In an exemplary embodiment, the pilot drill bit 24 may protrude from the center of a side of the cutting head 22. The pilot drill bit 24 may be used to drill a pilot hole into a cutting surface before the cutting edge 22A contacts and cuts into that cutting surface. In an exemplary embodiment, the cutting head 22 may be about 2.5 inches in diameter, and the pilot bit may be about 6 inches in length and about 5/16 inch in diameter.

The inner shaft 12 may drive the cutting head 22 by rotating around its longitudinal axis. The rotation of the inner shaft 12 may cause the cutting head 22 to rotate according to the rotation of the inner shaft, and thereby may cause the cutting head 22 to cut or bore out a circular shape on a cutting surface using the cutting head's 22 cutting edge 22A. In an exemplary embodiment, the inner shaft 12 may be at least 18 inches in length, or more preferably at least 20 inches in length, or more preferably about 22.5 inches in length and about ⅝ of an inch in diameter. The inner shaft may also be preferably less than 30 inches in length. The length of the inner shaft 12 may allow a user of average height standing underneath a soffit and roof of a typical house to be able to cut through the soffit and the roof using the saw 10 without having to climb up onto the roof, while not making the saw 10 too long and awkward for the user to hold and use in a vertical position.

A housing 26 may house at least a portion of the inner shaft 12. The housing 26 may serve as a guide and handle to steady the saw 10 as it is being used. The housing 26 may be magnetized so that a magnetic level may be coupled to the housing 26. In an exemplary embodiment, the housing 26 may be at least 16 inches in length, or more preferably at least 18 inches in length, or more preferably about 19.5 inches in length and about 2 and ⅛ inch in diameter. The housing 26 may also be preferably less than 25 inches in length. The length of the housing 26 may depend on the length of the inner shaft 12.

The inner shaft 12 may protrude from a pair of opposite ends of the housing 26. An end cap 28, which may allow the inner shaft 12 to ride outside the housing 26, may cap each of those ends of the housing 26. Each of the end caps 28 may have an opening that the inner shaft 12 may protrude through. An end bushing 30 may be fitted through each of the openings of the end caps 28. The end bushings 30 may allow the inner shaft 12 to rotate more smoothly. A C-clip 32 may ride in a machined groove on the inner shaft 12 and may help to keep the end bushings 30 within the housing 26. In an exemplary embodiment, the end caps may be made out of steel about ¼ inch thick and about 2 and ⅛ inch in diameter, having a hole about 0.63-inch in diameter in the center, and the end bushings 30 may be made of bronze.

A portion of the inner shaft 12 extending out of the end of the housing 26 opposite the cutting head 22 may include a chamfered portion 16. The chamfered portion 16 may be shaped so that it may be chucked into a drill, such as a ½-inch drill.

A head collet 18 may be situated between, and may be operably coupled to, the housing 26 and the cutting head 22. The head collet 18 may level the cutting head 22 and may help to ensure that the cutting head 22 is operable to make a level cut by providing a level surface that the cutting head 22 may make contact with. By making a level cut, the cutting head 22 may ensure that cuts through multiple surfaces, such as cuts through multiple walls, or cuts through a soffit and a roof, may line up with one another.

The inner shaft 12 may pass through the interior of the head collet 18 to the cutting head 22. The inner shaft 12 may also be coupled with the pilot drill bit 24 by the head collet 18, such as by being held to the pilot drill bit 24 by the head collet 18 and by being chucked to the pilot drill bit 24 via a set screw 20. The coupling of the inner shaft 12 and the pilot drill bit 24 may allow the inner shaft 12 to cause the pilot drill bit 24 to rotate upon rotation of the inner shaft 12.

In use, the rotating shaft saw 10 might be used to bore through one or more surfaces, such as the soffit and roof of a building, such as a home. A user, such an electrician, may stand underneath the targeted area of the soffit that is to be cut. The electrician may chuck the chamfered portion 16 of the inner shaft 12 into a drill, such as a ½-inch drill, and may hold the drill and the saw 10 via the housing 26 vertically so that the cutting head 22 is aimed towards the targeted area of the soffit. The electrician may also attach a magnetic level to the housing 26 of the saw 10 to ensure a level cut.

The electrician may set the pilot drill bit 24 on the targeted area of the soffit and engage the drill to start cutting the soffit using the pilot drill bit 24. The pilot drill bit 24 may continue to cut through the soffit until it is deep enough into the soffit for the cutting edge 22A of the cutting head to engage and cut the soffit.

Once the cutting edge 22A has cut through the soffit, the electrician may continue to move the drill and the attached saw 10 vertically towards the roof. Once again, the electrician may set the pilot drill bit 24 on the roof and cut the roof using the pilot drill bit 24. The pilot drill bit 24 may continue to cut through the roof until it is deep enough into the roof for the cutting edge 22A of the cutting head to engage and cut the soffit. The electrician may then cut through the roof using the saw 10.

Thus, the saw 10 may be used to cut through the soffit and the roof of a building from underneath, without needing to climb onto the roof to cut through the roof from above. While the foregoing has been described in the context of the saw 10 being used to cut through the soffit and the roof of a building from underneath the soffit, the saw 10 may be used in any instance where a straight hole may need to be cut through multiple surfaces, either horizontally or vertically.

It should be understood, of course, that the foregoing relates to exemplary embodiments of the invention and that modifications may be made without departing from the spirit and scope of the invention as set forth in the following claims.

What is claimed is:

1. A cutting apparatus comprising:
a cutting head having a cutting edge that is operable to cut through a surface;
a pilot drill bit operably coupled to the cutting head;
a housing; and
an inner shaft having at least a portion housed within the housing, the inner shaft being operably coupled to the cutting head, and the inner shaft being rotatable to cause the cutting head to rotate according to a rotation of the inner shaft to cut a circular shape.

2. The apparatus of claim 1 further comprising a head collet disposed between the housing and the cutting head, the head collet being operable to ensure a level rotation of the cutting head during rotation of the cutting head.

3. The apparatus of claim 1, wherein the inner shaft includes a chamfered portion exterior to the housing that is chuckable into a drill.

4. The apparatus of claim 1, wherein the inner shaft is at least 18 inches in length.

5. The apparatus of claim 4, wherein the inner shaft is at most 30 inches in length.

6. The apparatus of claim 2, wherein the pilot drill bit protrudes from the cutting head and is operable to cut a centering hole into the surface.

7. The apparatus of claim 6, wherein the inner shaft is operably coupled to the pilot drill bit.

8. The apparatus of claim 7, wherein the head collet couples the inner shaft to the pilot drill bit.

9. The apparatus of claim 1, wherein the housing comprises a pair of opposite ends that the inner shaft protrudes through.

10. The apparatus of claim 9, further comprising an end cap operably coupled to each of the pair of opposite ends of the housing, the end cap comprising an opening that the inner shaft runs through.
